(19) United States
(12) Patent Application Publication
(10) Pub. No.: US 2017/0158274 A1
(43) Pub. Date: Jun. 8, 2017

(54) DETACHABLE MOBILE MOUNTING DEVICE SYSTEM

(71) Applicant: Ruben R. Johnson, Peoria, IL (US)

(72) Inventor: Ruben R. Johnson, Peoria, IL (US)

(21) Appl. No.: 14/961,500

(22) Filed: Dec. 7, 2015

(51) Int. Cl. B62J 11/00

(52) U.S. Cl. CPC B62J 11/00

(57) ABSTRACT

A mobile mounting device system includes at least one bracket, a male mounting plate, a female mounting plate, an attachment assembly, and a sound system component. The at least one bracket includes an interior arced surface. The male mounting plate includes a base and an elongated protrusion with a protrusion shape. The female mounting plate includes a channel with a channel shape, the channel shape including the protrusion shape and clearance room to allow the protrusion to slide into the channel. The attachment assembly is configured to detachably connect one of the male mounting plate and the female mounting plate to the tubular element with at least one bracket. The sound system component is fixedly connected to the other of the male mounting plate and the female mounting plate, and configured to fixedly and detachably attach to the vehicle through inserting the protrusion into the channel.

### BACKGROUND OF THE INVENTION

The present invention generally relates to mobile mounting systems for mounting devices to vehicles.

While riding a vehicle, such as a bicycle, a person may desire to have music of their own choice playing. Mobile phones, or other personal electronic devices, are now capable of transmitting musical signals via wireless technology to speakers. The wireless technology may be Bluetooth or a similar technology. However, it may be difficult to attach a speaker, and sometimes the phone or personal electronic device, to the bicycle in a safe and convenient manner.

People may also desire to carry sports or other bulky equipment with them while riding a bicycle. For example, someone may desire to ride their bicycle to play in a sporting event, and may need to bring sporting equipment with them. Carrying the equipment may cause the bicycle to be off balance, and may cause a person to have to ride holding the handlebars of the bicycle with only one hand. Traditional baskets may not be large enough or strong enough to hold bulky equipment, and may be difficult to attach and detach from a bicycle.

As can be seen, there may be an ongoing need for mobile mounting systems to detachably connect with devices, and containers.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

In one aspect of the present invention, a mobile mounting device system for a vehicle with a tubular element includes at least one bracket, a male mounting plate, a female mounting plate, an attachment assembly, and a sound system component. The at least one bracket includes an interior arced surface. The male mounting plate includes a base and an elongated protrusion with a protrusion shape. The female mounting plate includes a channel with a channel shape, the channel shape including the protrusion shape and clearance room to allow the protrusion to slide into the channel. The attachment assembly is configured to detachably connect one of the male mounting plate and the female mounting plate to the tubular element with at least one bracket. The sound system component is fixedly connected to the other of the male mounting plate and the female mounting plate, and configured to detachably attach to the vehicle through inserting the protrusion into the channel.

In another aspect of the present invention, a mobile mounting device system for a vehicle with a tubular element includes at least one bracket, a first connection assembly, a second connection assembly, an elongated extender, an attachment assembly, and a first device. The least one bracket includes an interior arced surface. The first connection assembly includes a first male mounting plate including a first base and a first elongated protrusion with a first protrusion shape, and a first female mounting plate including a first channel with a first channel shape, the first channel shape including the first protrusion shape and clearance room to allow the first protrusion to slide into the first channel. The second connection assembly includes a second male mounting plate including a second base and a second elongated protrusion with a second protrusion shape, and a second female mounting plate including a second channel with a second channel shape, the second channel shape including the second protrusion shape and clearance room to allow the second protrusion to slide into the second channel. The elongated extender has a vehicle connection end fixedly connected to one of the first male mounting plate and the first female mounting plate, and a device mounting end fixedly connected to one of the second male mounting plate and the second female mounting plate. The attachment assembly is configured to detachably connect the other of the first male mounting plate and the first female mounting plate to the tubular element with at least one of the brackets with the interior arced surface adjacent the tubular element. The first device is fixedly connected to the other of the second male mounting plate and the second female mounting plate, and configured to detachably connect to the vehicle through inserting the first protrusion into the first channel and inserting the second protrusion into the second channel.

In another aspect of the present invention, a mobile mounting device system for detachably mounting a container to a neck of a bicycle includes a male mounting plate, a female mounting plate, the container, and at least one u-shaped bracket. The male mounting plate includes a base and an elongated protrusion with a protrusion shape. The female mounting plate includes a base and a channel with a channel shape, the channel shape including the protrusion shape and clearance room to allow the protrusion to slide into the channel. The container is fixedly connected to one of the male mounting plate and the female mounting plate. The at least one u-shaped bracket is configured to extend around the neck of the bicycle and fixedly attach the other of the male mounting plate and the female mounting plate to the neck of the bicycle.

These and other features, aspects and advantages of the present invention will become better understood with reference to the following drawings, description and claims.

### BRIEF DESCRIPTION OF THE DRAWINGS

FIG. 1 is a perspective and schematic view of a bicycle with a mobile mounting device system according to an exemplary embodiment of the present invention.

FIG. 2 is a perspective view of a first embodiment of a mobile mounting device system according to an exemplary embodiment of the present invention.

FIG. 3 is a perspective view of a second embodiment of a mobile mounting device system according to an exemplary embodiment of the present invention.

FIG. 4 is a perspective view of a third embodiment of a mobile mounting device system according to an exemplary embodiment of the present invention.

FIG. 5 is a perspective view of a female mounting plate according to an exemplary embodiment of the present invention.

FIG. 6 is a cross section of the female mounting plate of FIG. 5 along line 6 according to an exemplary embodiment of the present invention.

FIG. 7 is a cross section of another embodiment of a female mounting plate according to an exemplary embodiment of the present invention.

FIG. 8 is a perspective view of a male mounting plate according to an exemplary embodiment of the present invention.

FIG. 9 is a cross section of the male mounting plate of FIG. 8 along line 9 according to an exemplary embodiment of the present invention.

FIG. 10 is a cross section of another embodiment of a male mounting plate according to an exemplary embodiment of the present invention.

FIG. 11 is a cross section of a connection assembly according to an exemplary embodiment of the present invention.

FIG. 12 is a cross section of the female mounting plate of FIG. 5 along line 12 according to an exemplary embodiment of the present invention.

FIG. 13 is a perspective view of a bracket according to an exemplary embodiment of the present invention.

FIG. 14 is a perspective view of two brackets according to an exemplary embodiment of the present invention.

FIG. 15 is a perspective view of an assembly including a mounting plate fixedly connected to a bracket and detachably connected to another bracket with an attachment assembly according to an exemplary embodiment of the present invention.

FIG. 16 is a perspective view of a female mounting plate fixedly connected to a bracket according to an exemplary embodiment of the present invention.

FIG. 17 is another perspective view of a female mounting plate fixedly connected to a bracket according to an exemplary embodiment of the present invention.

FIG. 18 is a perspective view of a sound system component fixedly connected to a male mounting plate according to an exemplary embodiment of the present invention.

FIG. 19 is a perspective view of an assembly including a female mounting plate detachably connected to a tubular assembly with two brackets and an attachment assembly according to an exemplary embodiment of the present invention.

FIG. 20 is a perspective view of another embodiment of a female mounting plate according to an exemplary embodiment of the present invention.

FIG. 21 is a perspective view of another embodiment of a male mounting plate according to an exemplary embodiment of the present invention.

FIG. 22 is a perspective view of a fourth embodiment of a mobile mounting device system according to an exemplary embodiment of the present invention.

FIG. 23 is a perspective view of a fifth embodiment of a mobile mounting device system according to an exemplary embodiment of the present invention.

FIG. 24 is a schematic and expanded perspective view of a sixth embodiment of a mobile mounting device system according to an exemplary embodiment of the present invention.

FIG. 25 is a perspective view of a bicycle with a seventh embodiment of a mobile mounting device system according to an exemplary embodiment of the present invention.

FIG. 26 is a perspective view of a portion of a bicycle with an eighth embodiment of a mobile mounting device system according to an exemplary embodiment of the present invention.

FIG. 27 is a perspective view of the mobile mounting device system of FIG. 25 according to an exemplary embodiment of the present invention.

FIG. 28 is another perspective view of the mobile mounting device system of FIG. 25 according to an exemplary embodiment of the present invention.

FIG. 29 is a perspective view of an assembly including a reinforcement plate fixedly connected to a female mounting plate and detachably connected to a bicycle neck according to an exemplary embodiment of the present invention.

FIG. 30 is a perspective view of an assembly including a container fixedly connected to a male mounting plate with a reinforcement plate according to an exemplary embodiment of the present invention.

FIG. 31 is another perspective view of the assembly of FIG. 30 according to an exemplary embodiment of the present invention.

FIG. 32 is another perspective view of the assembly of FIG. 30 according to an exemplary embodiment of the present invention.

### DETAILED DESCRIPTION OF THE INVENTION

The following detailed description is of the best currently contemplated modes of carrying out the invention. Certain relational terms, such as top, bottom, front, and back are used while describing certain attributes in the drawings. These terms are relational only, and used for the purpose of imparting an understanding of the illustration, and should not be taken as limiting. The description is not to be taken in a limiting sense, but is made merely for the purpose of illustrating the general principles of the invention, since the scope of the invention is best defined by the appended claims.

Various inventive features are described below that can each be used independently of one another or in combination with other features. However, any single inventive feature may not address any of the problems discussed above or may only address one of the problems discussed above. Further, one or more of the problems discussed above may not be fully addressed by any of the features described below.

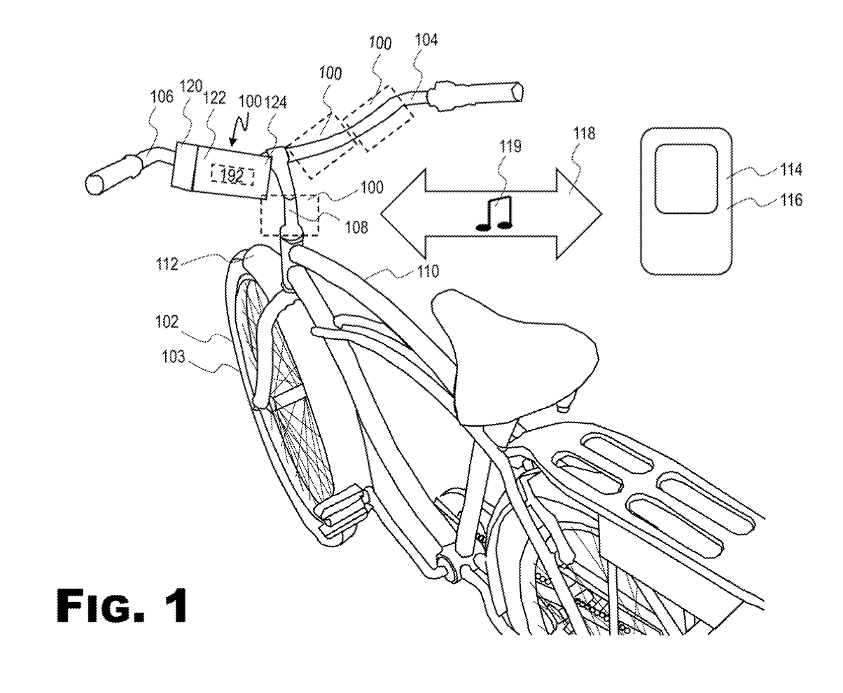

Referring now to FIG. 1, an exemplary vehicle 102 (in the illustrated embodiment, a bicycle 103), with an exemplary mobile mounting device system 100 is illustrated. The bicycle 103 may include tubular elements 104, such as handlebars 106, a neck 108, and frame pieces 110. The bicycle 103 may also include a fender 112. A person riding the bicycle 103 may have a personal electronic device 114, configured to play music or other audio files, or broadcast other audio (such as audio books, newscasts, sermons, and other audio performances) through generating audio signals 119 (illustrated as musical notes). The personal electronic device 114 may comprise a mobile phone 116, an electronic tablet (not shown), an MP3 player (not shown), or any other personal electronic device 116 as known in the art. The person may desire to carry the personal electronic device 114 in their pocket or another convenient place while riding the bicycle 103 and listening to music or other audio.

The personal electronic device 114 may be communicatively connected to a device 120 through a communication connector 118. The connector 118 may be a wireless connector and include one or more receivers and transmitters for transmitting the audio signals 119 from the personal electronic device 114 to the device 120. The communication connector 118 may be a Bluetooth® connection system, for example. The device 120 may be a sound system component 122 such as, for example, a speaker 124. In other embodiments, the device 120 may be another type of device, and may, in some instances, not be connected to the personal electronic device 114. Non-limiting examples of the device 120 include a portable light, a GPS navigation system unit, or the personal electronic device 114.

The device 120 may be a component of a detachable mobile mounting device system 100 and be detachably connected to one of the tubular elements 104 with a connection assembly 192. Though illustrated as being attached to the handlebars 106 on the left side of the bicycle 103 (as seen by a rider of the bicycle 103), the device 120 may be attached on the neck 108, other parts of the handlebars 106, or on other tubular elements 104.

FIGS. 2-4 illustrate several embodiments of the system 100. Referring now to FIG. 2 an exemplary first embodiment of the mobile mounting device system 100 is illustrated. The system 100 includes at least one bracket 140, a male mounting plate 126, a female mounting plate 132, an attachment assembly 150, and the sound system component 122. The bracket 140 includes an interior surface 144 which may be arced in shape. The male mounting plate 126 includes a base 128 and an elongated protrusion 130 with a protrusion shape. The female mounting plate 132 includes a channel 136 with a channel shape, the channel shape including the protrusion shape and clearance room to allow the protrusion 130 to slide into the channel 136. The attachment assembly 150 is configured to detachably connect one of the male mounting plate 126 and the female mounting plate 132 to the tubular element 108 with at least one bracket 140. The sound system component 122 is fixedly connected to the other of the male mounting plate 126 and the female mounting plate 132, and configured to detachably attach to the vehicle 102 through inserting the protrusion 130 into the channel 136. The male mounting plate 126 and the female mounting plate 132 may comprise a connection assembly 192.

In the embodiment illustrated, the male mounting plate 126 is fixedly connected to the sound system component 122, and the female mounting plate 132 is detachably attached to the handlebars 106. A bracket 140 may be fixedly attached to the female mounting plate 132, and another bracket 140 may be detachably attached to the other bracket 140 with the attachment assembly 150. The attachment assembly 150 may include bolts 152 and threaded apertures 154 in the brackets 140. One or more bolts 152 may be threaded through the threaded apertures in both brackets 140 and in some embodiments, the female mounting plate 132, to secure the female mounting plate 132 to the tubular element 108. The protrusion 130 may be inserted into the channel 136 to detachably attach the sound system component to the handlebars 106.

There may be some clearance room between the protrusion 130 and the channel 136 to allow for easier attachment. This may lead to some rattling sounds, and vibration between the components of the system 100 which may be undesirable. In some embodiments, filler material 138 may be inserted between the protrusion 130 and the channel 136. The filler material 138 may include facial tissue material, plastic or cellophane tape, thin pieces of plastic wrap, or any other type of flexible, thin material which would be known in the art.

As shown in the illustrated embodiments, the protrusion 130 slides into the channel 136 by moving the male mounting plate 126 in a first direction in relation to the female mounting plate 132. To remove the protrusion 130 from the channel (and thus the male mounting plate 126 from the female mounting plate 132) the male mounting plate 126 is moved in a second direction 180° opposite the first direction. In one embodiment, the only way to engage the male mounting plate 126 with the female mounting plate 132 is by moving the male mounting plate 126 in the first direction, and the only way to disengage the male mounting plate 126 from the female mounting plate 132 is by moving the male mounting plate 126 in the second direction. When engaged the male mounting plate 126 will not disengage by moving in a direction substantially perpendicular to the first direction or the second direction

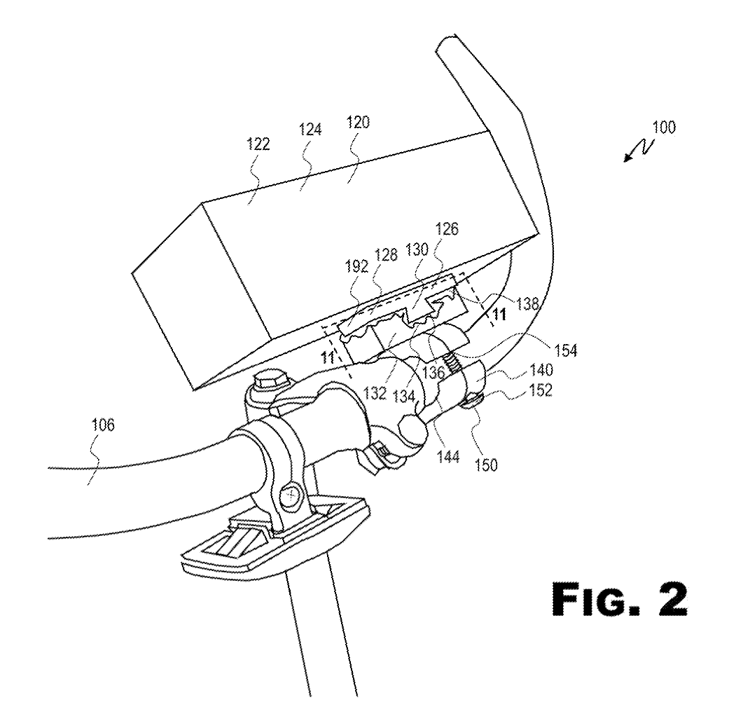

Referring now to FIG. 3, an exemplary second embodiment of the mobile mounting device system 100 is illustrated. The second embodiment is similar to the first, but is mounted on the neck 108 instead of the handlebars. In both embodiments, the female mounting plate 132 and the male mounting plate 126 are fixedly connected to the bracket 140 and the sound system component 122 respectively such that the protrusion 130 is inserted into the channel 136 by moving the sound system component 122 in a 1^{st} direction in relation to the female mounting plate 132. In the illustration, the 1^{st} direction is illustrated as a downward direction. In other embodiments, the female mounting plate 132 and the male mounting plate 126 may be connected to the bracket 140 and sound system component 122 respectively such that the protrusion 130 is inserted into the channel 136 by moving the sound system component 122 in other directions in relation to the female mounting plate 132 (as illustrated by the arrows). For example, the sound system component 122 may be moved in a 2^{nd} direction or a 3^{rd} direction, illustrated as right and left in FIG. 3.

Referring now to FIG. 4, an exemplary third embodiment of the mobile mounting device system 100 is illustrated. In the third embodiment, the system 100 is located on the handlebars 106. The system includes two brackets 140, each with a first end 146, and a second ends 148. The attachment assembly 150 includes bolts 152 threaded through threaded apertures 154 in the first end 146 of each bracket 140, and then threaded into threaded apertures 154 in the female mounting plate 132. The second end 148 of each bracket is wrapped around the tubular element 108 detachably connecting the one of the female mounting plate 132 to the tubular element 108. Each embodiment in FIGS. 2-4 shows bolts 152 and threaded apertures 154 as attachment assemblies 150. Other attachment assemblies 150 as known in the art could also be used.

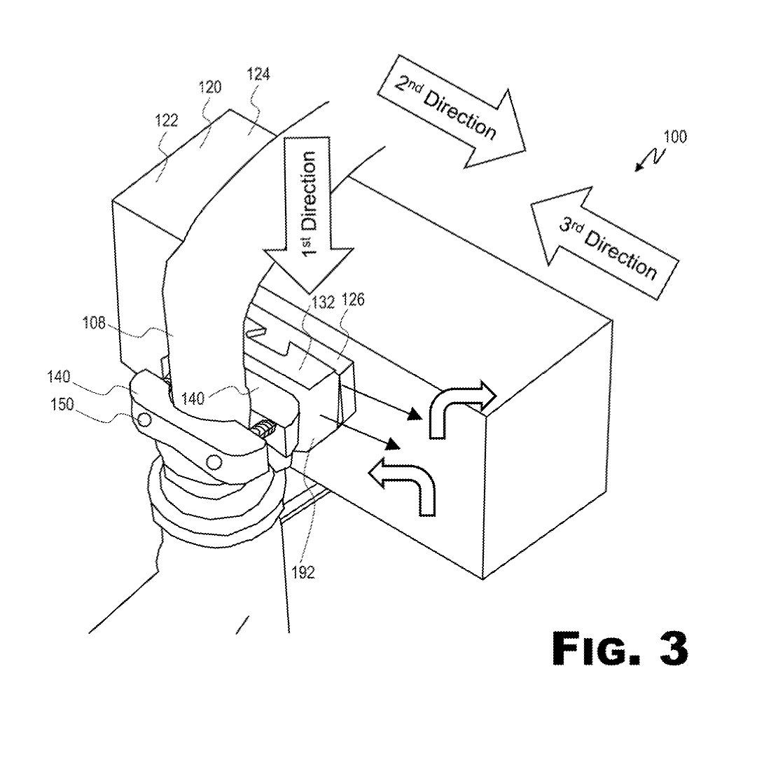

FIGS. 5-12 illustrate embodiments of the female mounting plate 132, the male mounting plate 126, and the connection assembly 192. Referring now to FIGS. 5-7, and 12 exemplary female mounting plates 132 are illustrated in perspective and cross sectional views. The female mounting plate 132 may include a base 134, a channel 136, apertures 168, a top 156, a bottom 158, a front 160, a back 162, a first side 164, and a second side 166. The female mounting plate 132 may be made of metal or a metal alloy, such as steel, aluminum, or alloys of either. In some embodiments, the female mounting plate 132 may be made of a sturdy plastic, rubber, or other sturdy solid. The female mounting plate 132 may be machined from a metal or metal alloy plate, molded, cast, or formed in another way known in the art. Although the female mounting plate 132 is illustrated with sharp edges, these edges may be machined to rounded edges. When the channel 136 is machined with rounded edges, especially around an entry mouth 137 it may allow for easier insertion of the protrusion 130.

In some embodiments, the female mounting plate 132 may be fixedly connected to one or more brackets 140 with adhesives. In other embodiments, the female mounting plate 132 may be bolted, riveted, welded, or in any other way fixedly connected to the one or more brackets 140 known in the art. As illustrated, the female mounting plate 132 includes two apertures which in some embodiments may be used to bolt or otherwise fixedly or detachably connect the female mounting plate 132 to one or more brackets 140.

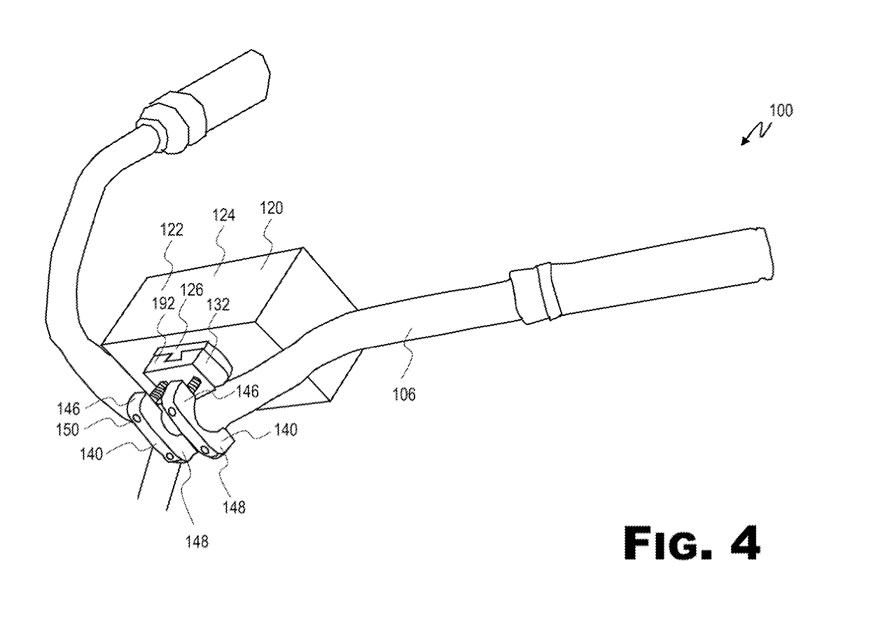

The channel 136 may extend downward from the top 156 part way into the base 134. As seen in FIG. 12 (a cross section of the female mounting plate 132 along line 12 of FIG. 5), the channel 136 may have an open end at the front 160 and extend part way to the back 162. The back wall of the channel 136 may be arced. The channel 136 may be generally centered between the first side 164 and the second side 166. As shown in FIG. 6 (a cross section of the female mounting plate 132 along line 6 of FIG. 5), the channel 136 may have a bottom and 2 sides. The sides may taper outward toward the base 134 first side 164 and second side 166 from the base top 156 moving towards the base bottom 158. FIG. 7 shows a cross section of an alternative embodiment of the female mounting plate 132. In this embodiment, the side walls of the channel 136 are arced outward towards the first side 164 and the second side 166.

The illustrated base 134 is a rectangular shaped plate with two rounded corners at the back 162. In other embodiments the base 134 may have other shapes. In some embodiments the shape of the top 156 of the base 134 may be similarly shaped to the top 170 (shown in FIG. 8) of the male mounting plate 126.

Referring now to FIGS. 8-10 male mounting plates 126 are illustrated in perspective and cross sectional views. The male mounting plate 126 may include a base 128, a protrusion 130, apertures 182, a top 170, a bottom 172, a front 174, a back 176, a first side 178, and a second side 180. The male mounting plate 126 may be made of metal or a metal alloy, such as steel, aluminum, or alloys of either. In some embodiments, the male mounting plate 126 may be made of a sturdy plastic, rubber, or other sturdy solid. The male mounting plate 126 may be machined from a metal or metal alloy plate, molded, cast, or formed in another way known in the art. Although the male mounting plate 126 is illustrated with sharp edges, these edges may be machined to rounded edges. When machined to rounded edges especially around an entry edge 131, it may allow the protrusion 130 to slide into the channel 136 more easily. The protrusion 130 may be integral with the base 128, or the protrusion 130 may be fixedly connected to the base with adhesive, bolts, rivets, welding, or any other means known in the art.

In some embodiments, the male mounting plate 126 may be fixedly connected to the device 120 with adhesives. In other embodiments, the male mounting plate 126 may be bolted, riveted, welded, or in any other way fixedly connected to the device 120 known in the art. As illustrated, the male mounting plate 126 includes two apertures which in some embodiments may be used to bolt or otherwise fixedly or detachably connect the male mounting plate 126 to the device. In some embodiments the male mounting plate 126 may be integral to the device 120. The base 128 and/or the protrusion 130 may be a portion of a part of the device 120 at manufacture.

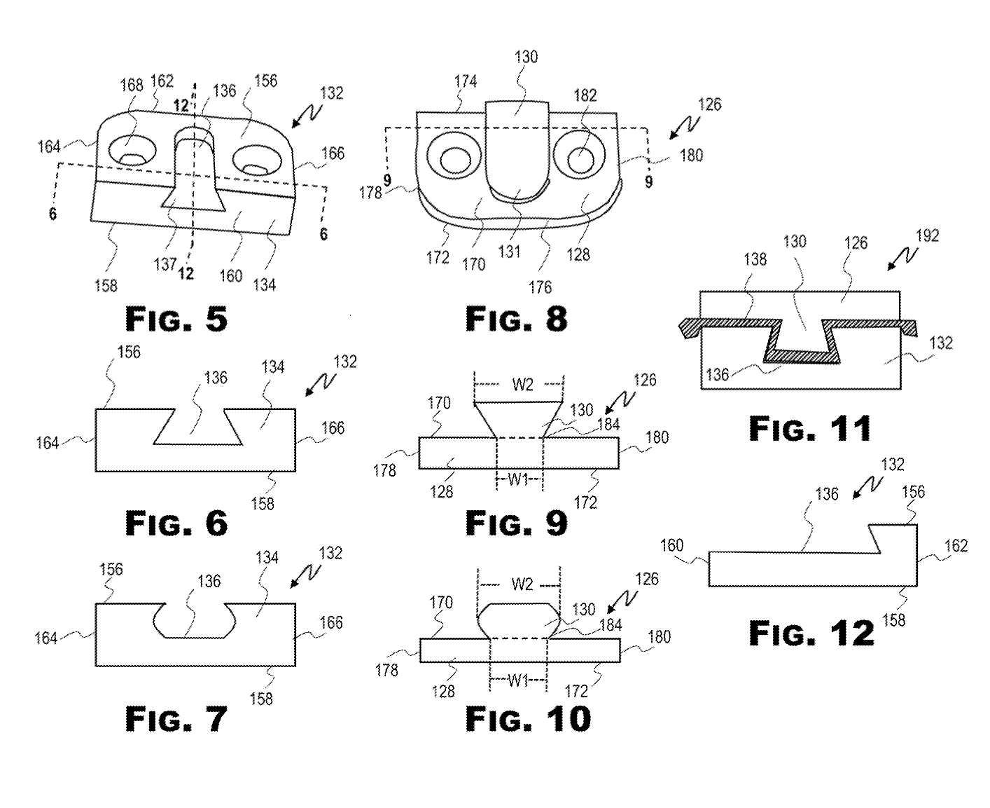

The protrusion 130 may be an elongated element rising from the base 128. The protrusion 130 may extend from the front 174 part way or the entire way to the back 176. The front of the protrusion 130 may be in the same plane as the front of the male mounting plate 126. The back of the protrusion 130 may be arced, allowing for easier insertion into the channel 136. The protrusion 130 may be generally centered between the first side 178 and the second side 184. As shown in FIGS. 9 and 10, the protrusion may attach to the base at an attachment plane 184. A cross section of the protrusion 130 perpendicular to the attachment plane 184 may have a first width W1 at the attachment plane 184, and a second width W2 different than the first width W1. The first width W1 may be less than the second width W2, thus holding the protrusion 130 in the channel 136 when inserted. As shown in FIG. 9 (a cross section of the male mounting plate 126 along line 9 of FIG. 8), the protrusion 130 may have a top and 2 sides. The sides may taper outward toward the base 128 first side 178 and second side 180 from the base top 170 moving upward to the protrusion 130 top. FIG. 10 shows a cross section of an alternative embodiment of the male mounting plate 126. In this embodiment, the side walls of the protrusion 130 are arced outward towards the first side 178 and the second side 180.

The illustrated base 128 is a rectangular shaped plate with two rounded corners at the back 176. In other embodiments the base 128 may have other shapes. The protrusion 130 may be similarly shaped with clearance room to the channel 136. When the protrusion 130 is inserted into the channel 136, the sides of the bases 128, 134 may generally line up together.

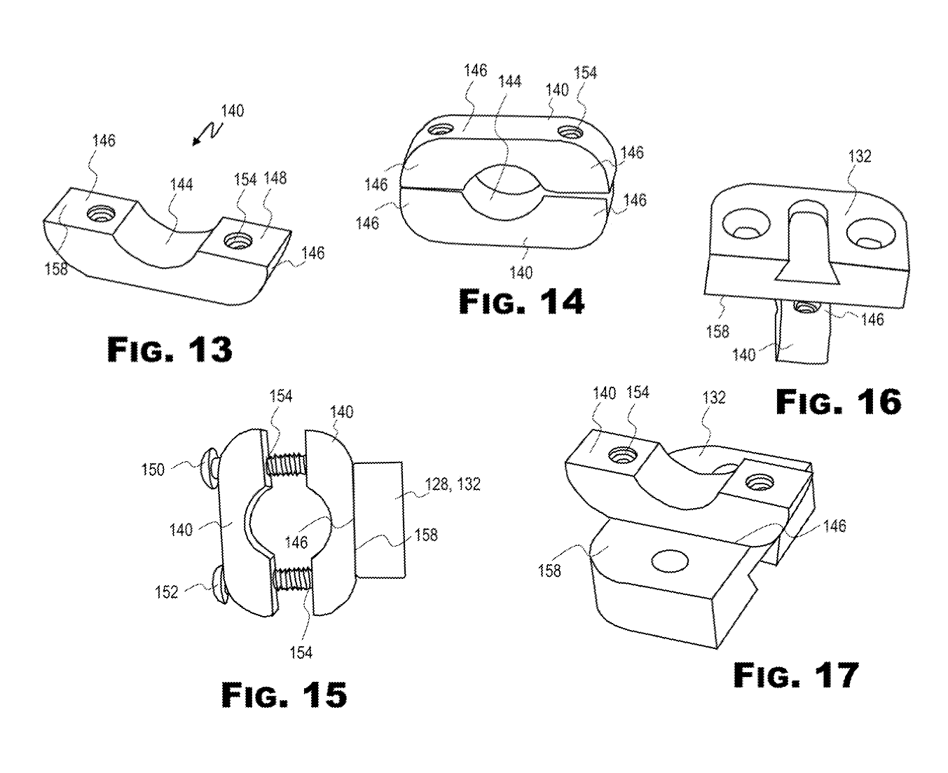

Referring now to FIG. 11, a cross section of an exemplary connection assembly 192 along line 11 of FIG. 2 is illustrated. The cross section illustrates the filler material between the channel 136 and the protrusion 130, and the base tops 156, 170.

FIG. 12 is a cross section of the female mounting plate of FIG. 5 along line 12 according to an exemplary embodiment of the present invention.

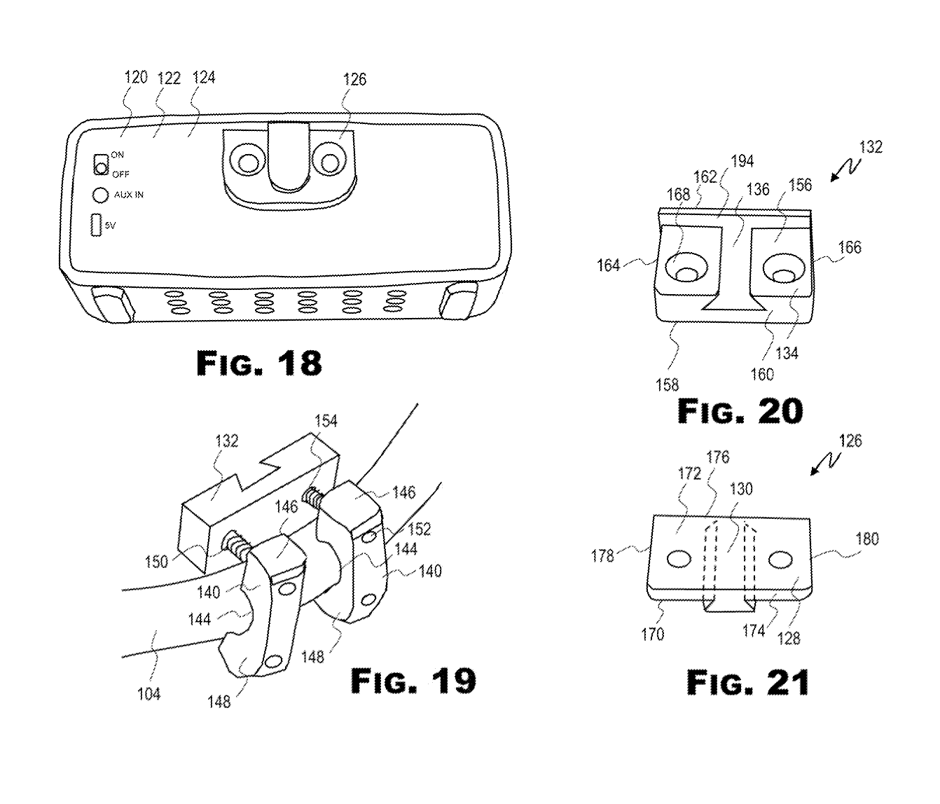

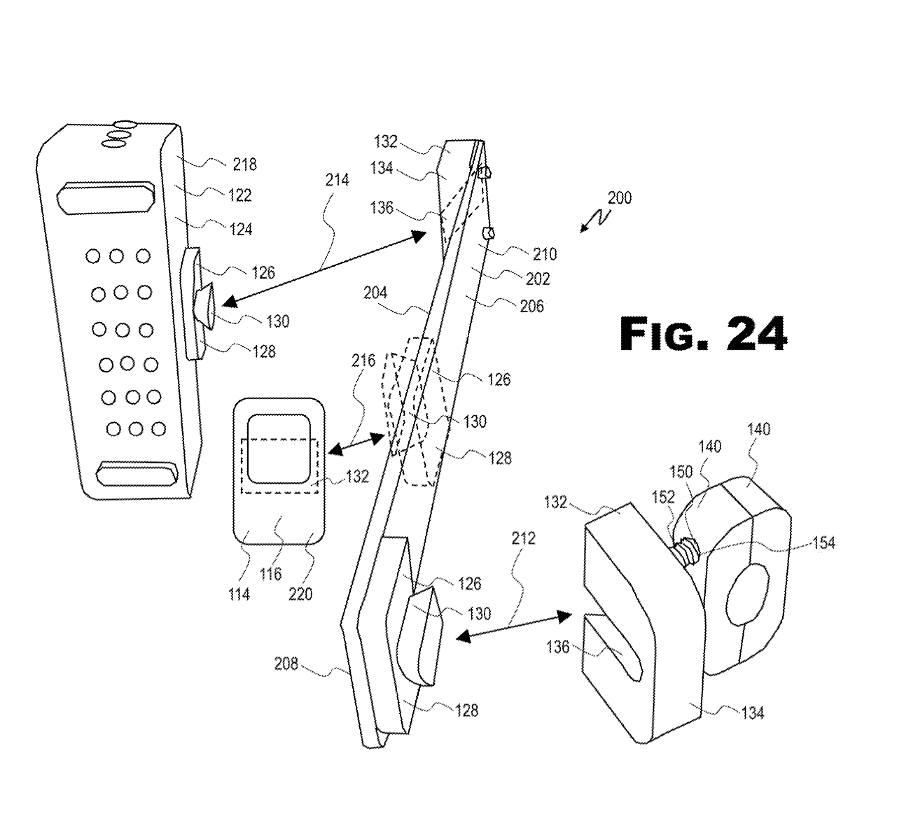

FIGS. 13-17 illustrate exemplary embodiments of the bracket 140 and assemblies of one or more brackets 140 with the female mounting plate 132. Referring now to FIG. 13 a perspective view of an exemplary bracket 140 is illustrated. The bracket 140 may have an interior surface 144, an exterior surface 146, a first end 146, a second end 148, and threaded apertures 154. The interior surface 144 may be shaped to abut one of the tubular elements 104. The threaded apertures 154 may be a component of one embodiment of the attachment assembly 150.

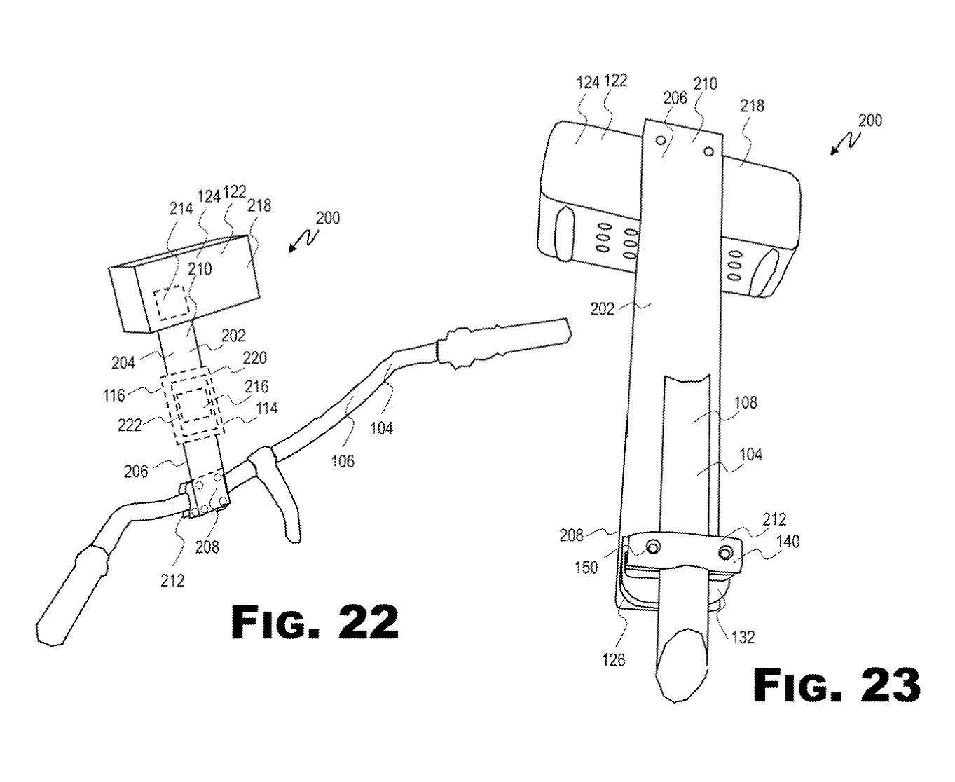

FIG. 14 shows two brackets 140 with first ends 146 together and second ends 148 together. This placement shows how a tubular element 104 may be placed between the brackets 140. In FIG. 15, the two brackets 140 are shown with the attachment assembly 150, including bolts 152, and the female mounting plate 132 or the male mounting plate 126. The female mounting plate 132 or male mounting plate 126 may be fixedly connected to one of the brackets. This assembly may be detachably attached to the vehicle 102 and left on. The device 120, fixedly connected to the other of the female mounting plate 132 or male mounting plate 126, may be detachably attached to the vehicle through inserting the protrusion 130 into the channel 136. Referring to FIGS. 15 and 16, perspective views of exemplary assemblies of the female mounting plate 132 fixedly connected to a bracket 140 are illustrated.

When riding the bicycle 103, a person may attach the device 120 and mounting plate 126, 132 assembly to the bicycle 103 and utilize the device. For example, the person may play music on the speaker 124 from the mobile phone 116, or use a GPS system. When parking the bicycle 103, the person may detach the device 120 and mounting plate assembly 126, 132 from the bicycle by sliding the protrusion 130 out of the channel 136. The device 120 and mounting plate 126, 132 assembly may then be kept in a safe place to prevent loss from such events as theft or damage by the environment.

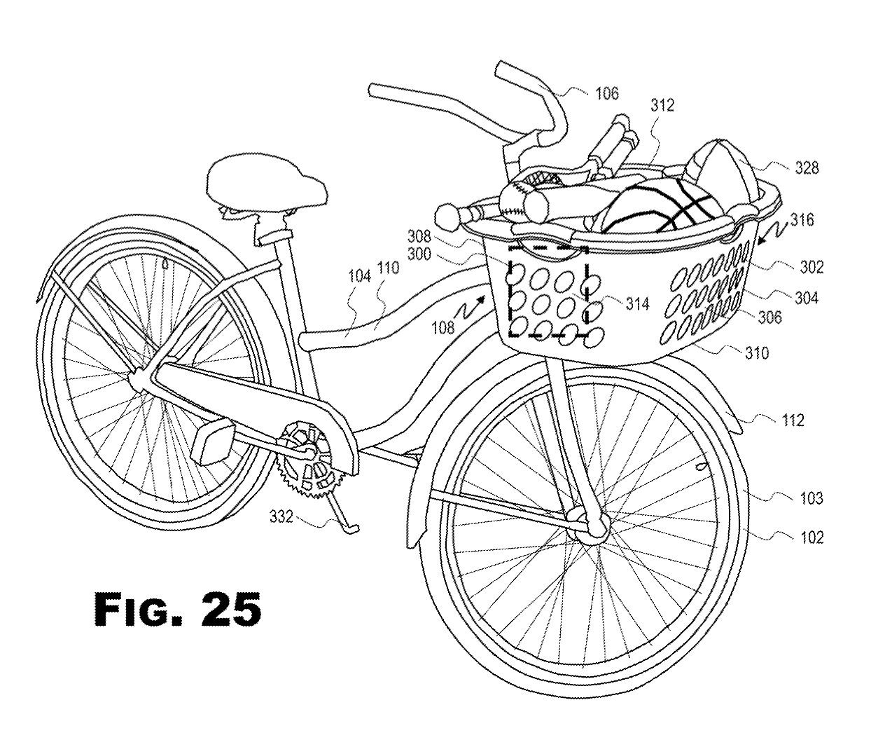

FIG. 18 illustrates a speaker 124 with the male mounting plate 126 fixedly connected. FIG. 19 illustrates another exemplary assembly including the female mounting plate 132 detachably connected to the tubular element 108 with two brackets 140 with the attachment assembly 150 including bolts 152 and threaded apertures 154.

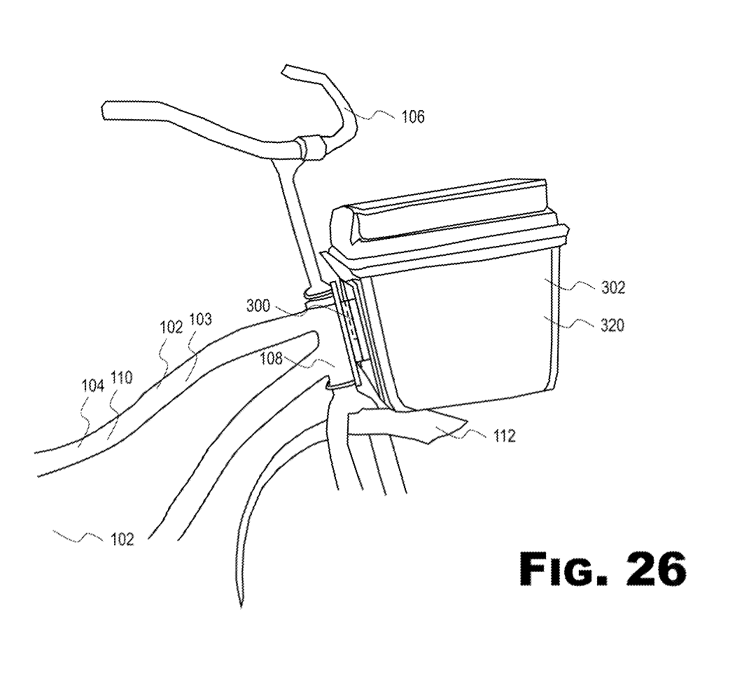

FIGS. 20 and 21 illustrate an alternative embodiment of the female mounting plate 132 (FIG. 20) and the male mounting plate 126 (FIG. 21) in a perspective view. The embodiments are configured to be used together in the system 100. The female mounting plate 132 is similar to other embodiments described above, but has a rim 194, or flange, protruding from the back 162 top 156 edge. The channel 136 extends from the front 160 to the front of the rim 194. The protrusion 130 on the male mounting plate 126 extends from the front 174 to the back 176. When the protrusion 130 is inserted into the channel 136, the back 176 of the base 128 abuts the rim 194.

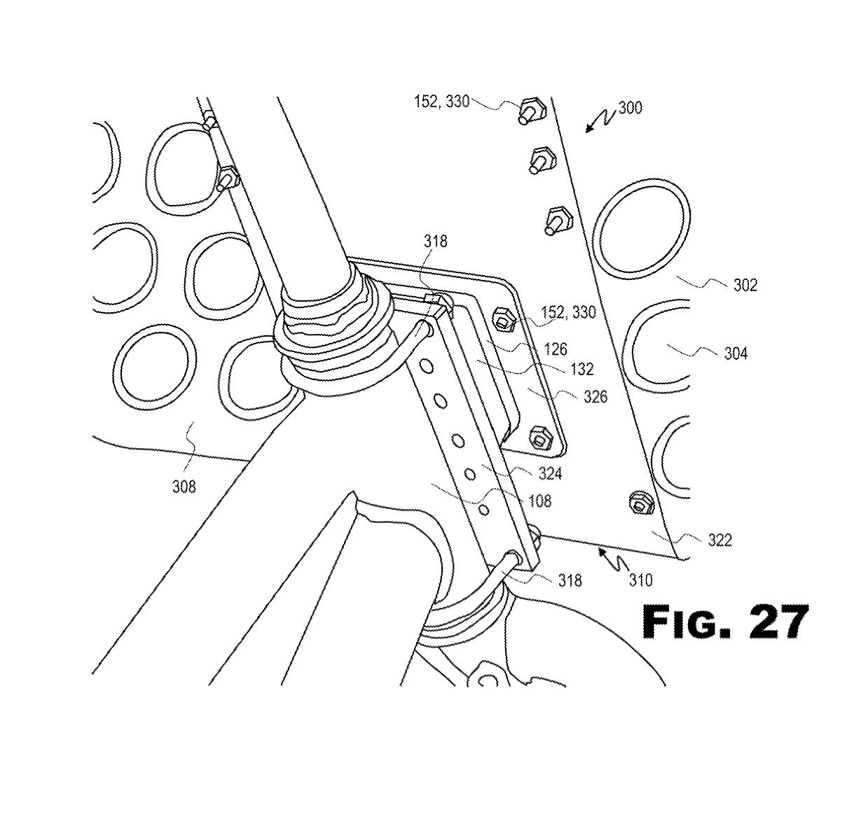

FIGS. 22-23 illustrate embodiments of the mobile mounting device system 200 which include an elongated extender 202. A person riding the vehicle 102 may want to mount a speaker 124 or other first device 218 in a convenient place to be able to see and reach the controls of the first device 218, while still being able to operate the vehicle 102 and watch and be aware of their environment. In addition, the person may want to mount another second device 220 in a convenient place for operation. The second device 220 may include the personal electronic device 114, which may comprise the mobile phone 114. These systems 100 include the at least one bracket 140, a first connection assembly 212, a second connection assembly 214, the elongated extender 202, the attachment assembly 150, and a first device. The at least one bracket 140 includes the interior surface 144. The first connection assembly includes a first male mounting plate 126 including a first base 130 and a first elongated protrusion 130 with a first protrusion shape, and a first female mounting plate 132 including a first channel 136 with a first channel shape, the first channel shape including the first protrusion shape and clearance room to allow the first protrusion 130 to slide into the first channel 136. The second connection assembly 214 includes a second male mounting plate 126 including a second base 128 and a second elongated protrusion 130 with a second protrusion shape, and a second female mounting plate 132 including a second channel 136 with a second channel shape, the second channel shape including the second protrusion shape and clearance room to allow the second protrusion 130 to slide into the second channel 136. The elongated extender 202 has a vehicle connection end 208 fixedly connected to one of the first male mounting plate 126 and the first female mounting plate 130, and a device mounting end 120 fixedly connected to one of the second male mounting plate 126 and the second female mounting plate 132. The attachment assembly 150 is configured to detachably connect the other of the first male mounting plate 126 and the first female mounting plate 132 to the tubular element 104 with at least one of the brackets 140 with the interior surface 144 adjacent the tubular element 144. The first device 218 is fixedly connected to the other of the second male mounting plate 126 and the second female mounting plate 132, and configured to detachably connect to the vehicle 102 through inserting the first protrusion 130 into the first channel 136 and inserting the second protrusion 130 into the second channel 136.

Referring now to FIG. 22, an exemplary mobile mounting device system 200 is illustrated. The extender 202 may include an elongated rectangular metal plate. The plate may be cut from and machined from steel or aluminum sheet metal, or cast, molded, or produced in other ways known in the art. In some embodiments, the extender 202 may be made from plastics or rubber as would be known in the art.

In some embodiments, as shown by the dashed lines in the illustration, a third connection assembly 216 may detachably mount the second device 220 to the vehicle 102. The a third connection assembly may include a third male mounting plate 126 including a third base 128 and a third elongated protrusion 130 with a third protrusion shape, and a third female mounting plate 132 including a third channel with a third channel shape, the third channel shape including the third protrusion shape and clearance room to allow the third protrusion 130 to slide into the third channel 136. The second device 220 may be fixedly connected to one of the third male mounting plate 126 and the third female mounting plate 132. The other of the third male mounting plate 126 and the third female mounting plate 132 is fixedly connected to a mounting area of the elongated extender 202. The second device 220 is configured to detachably connect to the vehicle 102 through inserting the third protrusion 130 into the third channel 136. The second device 220 may comprise the mobile phone 114 or another personal electronic device 116. The personal electronic device 116 may include a cover 222 to which one of the third male mounting plate 126 and the third female mounting plate 132 is fixedly connected to. The personal electronic device 116 may be placed in the cover 222 when it is desired to mount it to the vehicle 102, and taken out of the cover 222 when a person parks the vehicle 102. The cover 222 can be removed from the vehicle if it is desired to mount a different second device 220.

An ordinary person skilled in the art will understand that the device 120, first device 218, and second device 220 may include multiple devices, each with one of the male mounting plate 126 or the female mounting plate 132 fixedly attached to them. One of the other of the male mounting plate 126 or the female mounting plate 132 may be mounted on the vehicle 102, and the multiple devices can be interchangeably mounted and dismounted through inserting and removing the protrusion 130 into and out of the channel 136.

Referring now to FIG. 23, another exemplary embodiment of the mobile mounting device system 200 with the extender 202 is illustrated in a perspective view. In this embodiment, the extender 202 is mounted to the tubular element 104 in a different orientation.

Referring now to FIG. 24, an exemplary embodiment of the mobile mounting device system 200 with the extender 202 is illustrated in an expanded view.

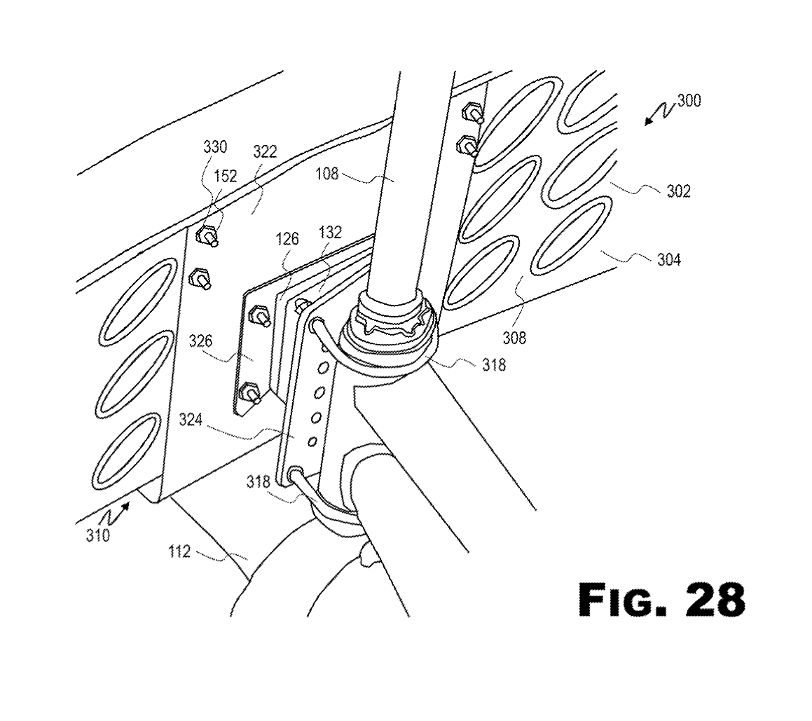

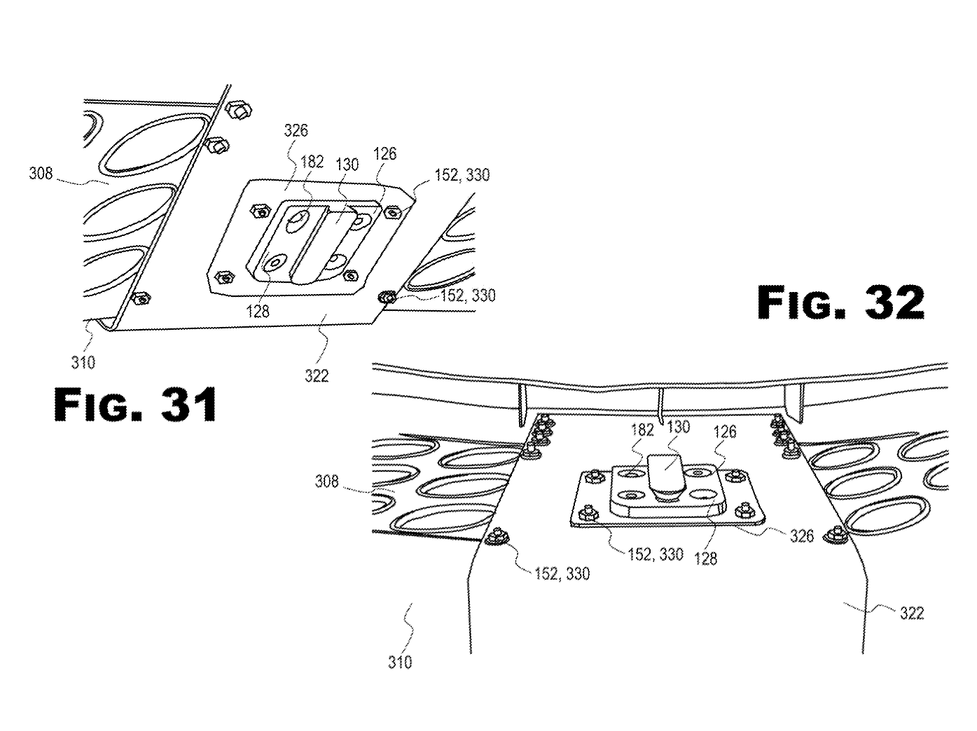

FIGS. 25-32 illustrate another exemplary embodiment of a mobile mounting device system 300. People riding bicycles 103 may desire to carry heavy items such as, but not limited to, sporting equipment, tools, and/or food in a cooler with them. Carrying these items may be difficult as they may be heavy and/or bulky. Current baskets and other containers for carrying items on bicycles may not be large enough to hold all the desired items, and may cause the bicycle to be out of balance and difficult to ride or park. A person may also desire to interchange containers for carrying items on a bicycle without a long or involved process of removing one container and fastening the other container onto the bicycle.

Referring now to FIG. 25, a perspective view of the bicycle 103 with an exemplary embodiment of the mobile mounting device system 300 for detachably mounting a container 302 to a neck of the bicycle 103 is illustrated. The system 300 includes a male mounting plate 126, a female mounting plate 132, the container 302, and at least one u-shaped bracket 318. The male mounting plate 126 includes a base 128 and an elongated protrusion 130 with a protrusion shape. The female mounting plate 132 includes a base 134 and a channel 136 with a channel shape, the channel shape including the protrusion shape and clearance room to allow the protrusion 130 to slide into the channel 136. The container 302 is fixedly connected to one of the male mounting plate 126 and the female mounting plate 132. The at least one u-shaped bracket 318 is configured to extend around the neck 108 of the bicycle 103 and fixedly attach the other of the male mounting plate 126 and the female mounting plate 132 to the neck 108 of the bicycle 103. In one embodiment, the u-shaped bracket 318 may be a U-bolt. In another embodiment, the u-shaped bracket 318 may include a strap fastening the other of the male mounting plate 126 and the female mounting plate 132 to the neck 108 of the bicycle 103.

In the embodiment illustrated the container 302 comprises a basket 304 suitable for carrying heavy and bulky sporting equipment 328. The basket 304 may include a front 306, a back 308, a bottom 310, and a top 312. The system 300 may be configured to mount the basket 304 on the neck 108 such that the bottom 310 is above the fender 112, and the top 312 is below the handlebars 106. The basket 304 may be mounted generally centered in relation to the neck 108. Utilizing the system 300, the equipment 328 or other items weight may be distributed such that when the bicycle 103 is parked with the kickstand 332 extended, the bicycle 103 will stand and not fall over.

Referring now to FIG. 26 a perspective view of a portion of the bicycle 103 with an exemplary embodiment of the mobile mounting device system 300 is illustrated. In this embodiment, the container 302 is illustrated as a tool box 320. This allows a person to ride the bicycle 103 to a job site with their tools balanced on the bicycle 103. When the person gets to the job site, they can easily detach the tool box and take it with them to the job. The different containers 302 with one of the male mounting plate 126 or female mounting plate 132 fixedly attached to them may be interchangeably mounted to the bicycle 103 in an easy and uncomplicated manner.

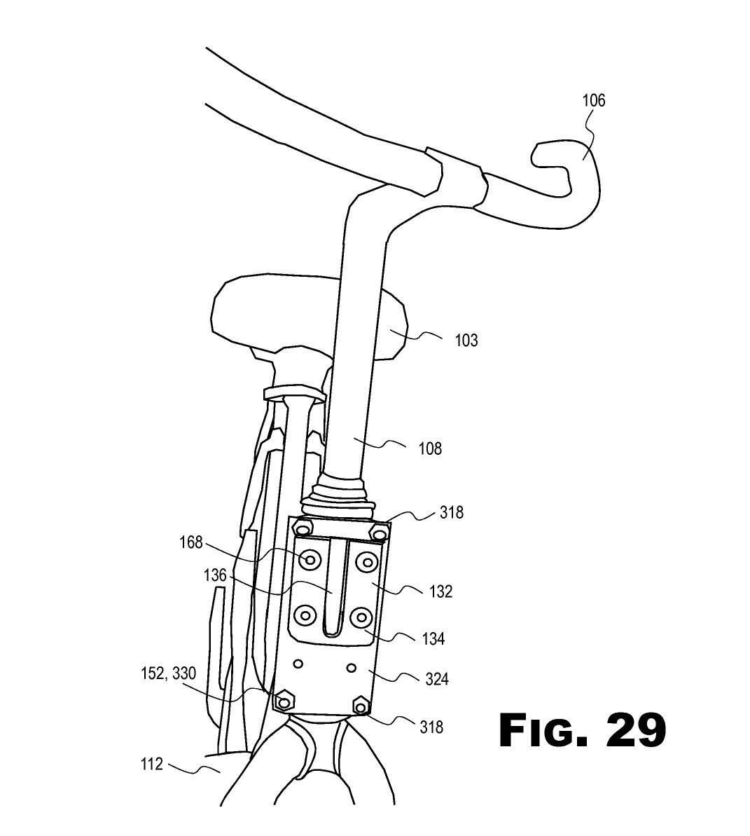

Referring now to FIG. 27, a perspective view of a portion of the mobile mounting device system 300 of FIG. 25 is illustrated. In this embodiment, a first reinforcement plate 322 is fixedly connected to the basket 304 on the back 308 and bends to attach and also reinforce the bottom 310. The first reinforcement plate 322 may be fixedly attached to the basket 304 with nuts 330 and bolts 152. In other embodiments other means of attachment such as adhesives, rivets, welding, or other means known in the art may be used. In some embodiments, the basket 304 or other container 302 may not require reinforcement, and the reinforcement plate 322 may not be a component of the system 300. A third reinforcement plate 326 may be fixedly attached to the basket 304 and/or the first reinforcement plate 322 with nuts 330 and bolts 152 or other means of attachment as detailed above. The male mounting plate 126 or the female mounting plate 132 may be fixedly attached to the third reinforcement plate 326 with adhesive, bolts 152, nuts 330, rivets, welding, or other means. In some embodiments one or more of the reinforcement plates 322, 326 and the mounting plates 126, 132 may be integrally formed together. In the illustrated embodiment the male mounting plate 126 is fixedly attached to the basket 304.

A second mounting plate 324 may be fixedly attached to the neck 108 of the bicycle 103 with a first u-shaped bracket 318 at the bottom, and a second u-shaped bracket 318 at the top. The u-shaped brackets 318 may be steel rods bent or otherwise formed into a u-shape and attached to the second reinforcement plate with nuts 330. The other of the male mounting plate 126 and the female mounting plate 132 may be fixedly attached to the second mounting plate 324, and thus the bicycle 103. In the embodiment illustrated, it is the female mounting plate 132 which is attached to the neck 108.

Referring now to FIG. 28, another perspective view of the mobile mounting device system 300 of FIG. 25 is illustrated.

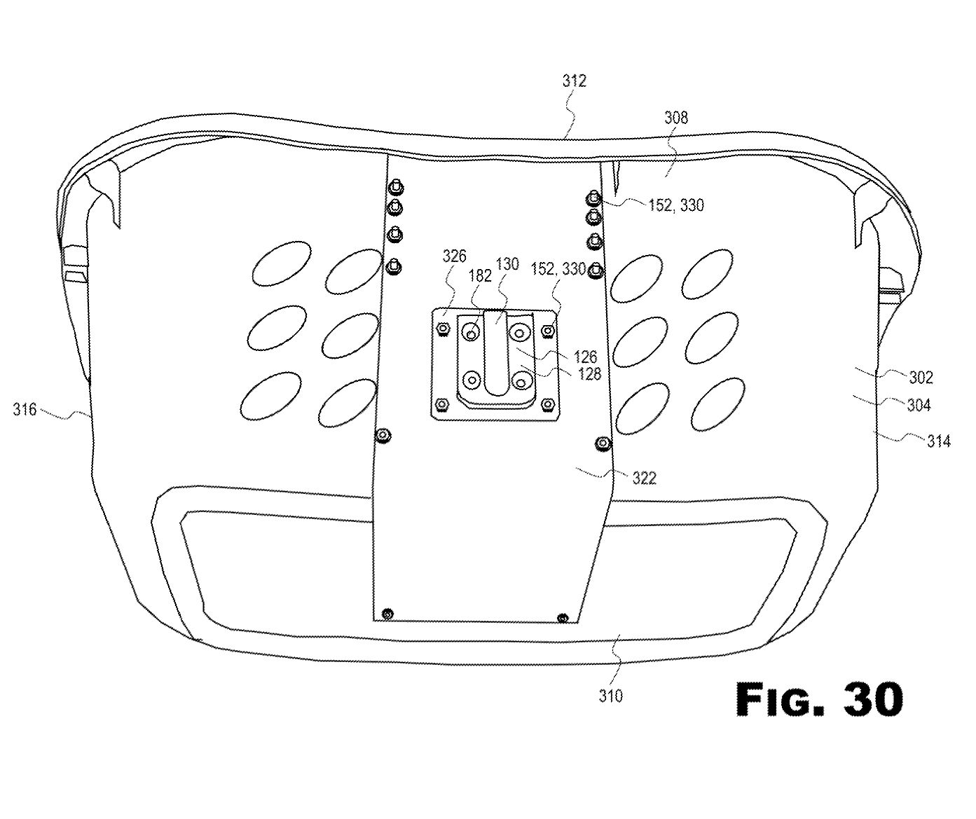

Referring now to FIG. 29, a perspective view of an assembly including the second mounting plate 324 fixedly connected to the female mounting plate 132 and fixedly and detachably connected to the neck 108 is illustrated. This assembly may remain on the bicycle 103, and various containers 302 fixedly attached to the male mounting plate 126 may be interchangeably attached by inserting or removing the protrusion 130 into or from the channel 136.

Referring now to FIGS. 30-32 several perspective views of an assembly including the container 302 fixedly connected to the male mounting plate 126 with the first reinforcement plate 322 and the third reinforcement plate 326 are illustrated.

It should be understood, of course, that the foregoing relates to exemplary embodiments of the invention and that modifications may be made without departing from the spirit and scope of the invention as set forth in the following claims.

I claim:

1. A mobile mounting device system for a vehicle with a tubular element, comprising:
at least one bracket including an interior arced surface;
a male mounting plate including a base and an elongated protrusion with a protrusion shape;
a female mounting plate including a channel with a channel shape, the channel shape including the protrusion shape and clearance room to allow the protrusion to slide into the channel;
an attachment assembly configured to detachably connect one of the male mounting plate and the female mounting plate to the tubular element with at least one bracket; and
a sound system component fixedly connected to the other of the male mounting plate and the female mounting plate, and configured to detachably attach to the vehicle through inserting the protrusion into the channel.

2. The system of claim 1, further including:
an attachment plane on the male mounting plate where the protrusion is connected to the base; and
a protrusion cross section perpendicular to the attachment plane, the cross section including a first width at the intersection of the cross section and the attachment plane, and a second width parallel to the first width and different from the first width; and
wherein the second width is greater than the first width.

3. The system of claim 1, wherein the protrusion includes a protrusion end, and the protrusion end tapers in width.

4. The system of claim 1, wherein:
the at least one bracket includes a first bracket and a second bracket;
the first bracket is fixedly connected to one of the male mounting plate and the female mounting plate; and
the second bracket is configured to be detachably connected to the first bracket with the attachment assembly to detachably connect the one of the male mounting plate and the female mounting plate to the tubular element.

5. The system of claim 1, wherein:
the at least one bracket includes a first bracket including a first mounting plate attachment end and a first tubular element attachment end;
the first mounting plate attachment end is configured to detachably connect to one of the male mounting plate and the female mounting plate with the attachment assembly; and
the first tubular element attachment end is configured to wrap around the tubular element detachably connecting the one of the male mounting plate and the female mounting plate to the tubular element.

6. The system of claim 5, wherein:
the at least one bracket includes a second bracket including a second mounting plate attachment end and a second tubular element attachment end;
the second mounting plate attachment end is configured to detachably connect to the one of the male mounting plate and the female mounting plate with the attachment assembly; and
the second tubular element attachment end is configured to wrap around the tubular element detachably connecting the one of the male mounting plate and the female mounting plate to the tubular element.

7. The system of claim 1, wherein the vehicle is a bicycle, and the tubular element is one of a handlebar and a neck of the bicycle.

8. The system of claim 1, further comprising filler material for inserting between the male mounting plate and the female mounting plate when the protrusion is inserted into the channel.

9. A mobile mounting device system for a vehicle with a tubular element, comprising:
at least one bracket including an interior arced surface;
a first connection assembly including a first male mounting plate including a first base and a first elongated protrusion with a first protrusion shape, and a first female mounting plate including a first channel with a first channel shape, the first channel shape including the first protrusion shape and clearance room to allow the first protrusion to slide into the first channel;
a second connection assembly including a second male mounting plate including a second base and a second elongated protrusion with a second protrusion shape, and a second female mounting plate including a second channel with a second channel shape, the second channel shape including the second protrusion shape and clearance room to allow the second protrusion to slide into the second channel;
an elongated extender having a vehicle connection end fixedly connected to one of the first male mounting plate and the first female mounting plate, and a device mounting end fixedly connected to one of the second male mounting plate and the second female mounting plate;
an attachment assembly configured to detachably connect the other of the first male mounting plate and the first female mounting plate to the tubular element with at least one of the brackets with the interior arced surface adjacent the tubular element;
a first device fixedly connected to the other of the second male mounting plate and the second female mounting plate, and configured to detachably connect to the vehicle through inserting the first protrusion into the first channel and inserting the second protrusion into the second channel.

10. The system of claim 9, further including:
a third connection assembly including a third male mounting plate including a third base and a third elongated protrusion with a third protrusion shape, and a third female mounting plate including a third channel with a third channel shape, the third channel shape including the third protrusion shape and clearance room to allow the third protrusion to slide into the third channel; and
a second device fixedly connected to one of the third male mounting plate and the third female mounting plate; and
wherein the other of the third male mounting plate and the third female mounting plate is fixedly connected to a mounting area of the elongated extender, and the second device is configured to detachably connect to the vehicle through inserting the third protrusion into the third channel.

11. The system of claim 10, wherein the first device and the second device are sound system components, and are communicatively connected.

12. The system of claim 11, wherein one of the first device and the second device is a speaker, and the other of the first device and the second device is a mobile electronic device for sending sound signals to the speaker.

13. The system of claim 8, wherein the elongated extender comprises a rectangular shaped metal plate.

14. The system of claim 8, wherein the vehicle comprises a bicycle, and the tubular element comprises a handlebar of the bicycle.

15. A mobile mounting device system for detachably mounting a container to a neck of a bicycle, comprising:
a male mounting plate including a base and an elongated protrusion with a protrusion shape;
a female mounting plate including a base and a channel with a channel shape, the channel shape including the protrusion shape and clearance room to allow the protrusion to slide into the channel;
the container fixedly connected to one of the male mounting plate and the female mounting plate; and
at least one u-shaped bracket configured to extend around the neck of the bicycle and fixedly attach the other of the male mounting plate and the female mounting plate to the neck of the bicycle.

16. The system of claim 15, wherein the container is a basket configured to carry sports equipment.

17. The system of claim 15, wherein the container is a tool box.

18. The system of claim 15, further comprising a first reinforcement plate fixedly connecting the container to the one of the male mounting plate and the female mounting plate.

19. The system of claim 15, further comprising a second reinforcement plate fixedly connected to the other of the male mounting plate and the female mounting plate; and wherein one of the u-shaped brackets includes a first end and a second end, and the first end and the second end are configured to detachably connect to the second reinforcement plate.

20. The system of claim 15, wherein the container is fixedly connected to the male mounting bracket; and the at least one u-shaped bracket is configured to extend around the neck of the bicycle and fixedly attach the female mounting plate to the neck of the bicycle.
